(19) United States
(12) Patent Application Publication
(10) Pub. No.: US 2019/0283540 A1
(43) Pub. Date: Sep. 19, 2019

(54) VENTILATION FLAP ARRANGEMENT, METHOD FOR THE PRODUCTION THEREOF AND EMBOSSING DIE USED IN THIS METHOD

(71) Applicant: EuWe Eugen Wexler Holding GmbH & Co. KG, Lauf (DE)

(72) Inventor: Helge JANSEN, Sinzing (DE)

(21) Appl. No.: 16/353,289

(22) Filed: Mar. 14, 2019

(30) Foreign Application Priority Data
Mar. 15, 2018 (DE) 10 2018 203 954.2

(51) Int. Cl. B60H 1/24

(52) U.S. Cl. CPC B60H 1/249; F24F 13/14

(57) ABSTRACT

A ventilation flap arrangement, in particular for venting a motor vehicle interior, comprises one or a plurality of flexible cover flaps and a frame for holding the cover flaps, the frame having a receiving groove for a cover flap, the receiving groove being formed by two side cheeks, and the cover flap being non-detachably connected, at its longitudinal edge, with the receiving groove of the frame by embossing. This embossed connection acts upon the cover flap in a clamping manner in a longitudinal-edge clamping area thereof. In each case one or a plurality of openings are provided close to the longitudinal edge at least on one side of the longitudinal-edge clamping area of the cover flap, with the side cheek projecting therein with in each case one embossed projection without applying a clamping force.

### CROSS-REFERENCE TO RELATED APPLICATIONS

This application claims the priority of German Patent Application Serial No. DE 10 2018 203 954.2 filed on Mar. 15, 2018, pursuant to 35 U.S.C. 119(a)-(d), the content of which is incorporated herein by reference in its entirety as if fully set forth herein.

### FIELD OF THE INVENTION

The invention relates to a ventilation flap arrangement, in particular for venting a motor vehicle interior, with cover flaps and a frame for holding the cover flaps. The invention further relates to a method of producing a ventilation flap arrangement of this type and to an embossing die used in this method.

### BACKGROUND OF THE INVENTION

A ventilation flap arrangement is known from DE 40 02 052 A1, the ventilation flap comprising an inner frame, an outer housing and cover flaps, wherein these cover flaps, which consist of a very soft, flexible material, are clamped between the inner frame and the outer housing. A ventilation flap arrangement of this type is produced in an elaborate assembly process with a large number of individual components.

Furthermore, it is known from DE 195 48 551 A1 that cover flaps are produced in one piece with a frame in conventional two-component injection molding processes. These manufacturing processes require elaborate tools and, optionally, injection molding machines adapted thereto. The production of a ventilation flap arrangement in a multi-component injection molding process is expensive.

Furthermore, it is known from DE 195 48 551 A1 and from EP 0 645 268 A1 to secure the cover flaps by means of a connection strip molded onto the frame or by means of tabs attached thereto. Cover flaps secured in this manner may cause problems in terms of a sealing contact with the frame of a ventilation flap arrangement.

The closest prior art, which discloses a ventilation flap arrangement, in particular for venting a motor vehicle interior, comprising one or more flexible cover flaps and a frame for holding the cover flaps, the frame having a receiving groove for a cover flap, the receiving groove being formed by two side cheeks, and the cover flap being non-detachably connected, at its longitudinal edge, with the receiving groove of the frame by embossing, and a corresponding production method, in particular for venting a motor vehicle interior, comprising the following method steps: providing one or a plurality of flexible cover flaps, providing a frame for holding the cover flaps, wherein the frame has a receiving groove for a cover flap, the receiving groove being formed by two side cheeks, inserting an edge of the cover flap between the two side cheeks of the receiving groove of the frame, and non-detachably connecting the cover flap with the receiving groove by embossing, is provided by EP 2 184 191 B1. In this disclosure, various embossed connections are shown, relating on the one hand to a full embossing operation carried out along the entire length of the edges of the cover flaps to connect them entirely by clamping, and to a fixing operation on the other hand where embossed projections project in corresponding openings distributed along the length of the edge of the cover flaps.

When it comes to full embossing, there is the problem that the soft elastic material of the cover flaps may deform as a result of thermally induced stresses, for example, so the tightness of the ventilation flap arrangement can no longer be guaranteed. When it comes to the fixing operation carried out by means of the embossed projections projecting in openings in the cover flaps, the stability of the connection between the cover flap and the frame requires improvement as the cover flap is prone to tearing in particular in the remaining thin webs between the openings and the edge of the cover flap.

### SUMMARY OF THE INVENTION

Therefore, the invention is based on the object of providing a ventilation flap arrangement and a method of producing a ventilation flap arrangement of this type in which a low-stress connection is provided between the cover flap and the frame while ensuring a high retaining force. As a result, the tightness and the tear strength of the cover flap is improved.

For the product to be provided, this object is achieved by a ventilation flap arrangement, in particular for venting a motor vehicle interior, comprising one or more flexible cover flaps and a frame for holding the cover flaps, the frame having a receiving groove for a cover flap, the receiving groove being formed by two side cheeks, and the cover flap being non-detachably connected, at its longitudinal edge, with the receiving groove of the frame by embossing, wherein this embossed connection acts upon the cover flap in a clamping manner in a longitudinal-edge clamping area thereof, and one or a plurality of openings formed close to the longitudinal edge are in each case provided at least on one side of the longitudinal-edge clamping area of the cover flap, with at least one side cheek projecting therein with in each case one embossed projection without applying a clamping force; for the method to be provided, this object is achieved by a method of producing a ventilation flap arrangement, in particular for venting a motor vehicle interior, comprising the following method steps: providing one or a plurality of flexible cover flaps, providing a frame for holding the cover flaps, wherein the frame has a receiving groove for a cover flap, the receiving groove being formed by two side cheeks, inserting an edge of the cover flap between the two side cheeks of the receiving groove of the frame, and non-detachably connecting the cover flap with the receiving groove by embossing, wherein the embossing operation is carried out in such a way that the cover flap is acted upon in a clamping manner only in its longitudinal-edge clamping area, preferably central area, and, on both sides of the longitudinal-edge clamping area, preferably central area, of the cover flap, the at least one side cheek projects, with in each case one embossed projection, in one or a plurality of openings formed close to the longitudinal edge without applying a clamping force. The gist of the invention is that the cover flap is acted upon in a clamping manner, causing it to be deformed heavily, in a longitudinal-edge clamping area, preferably in a longitudinal-edge central area, which ensures a high stability of the flap in the receiving groove of the frame. On one side of this clamping area or on both sides thereof—i.e. when a clamping is provided in a central area—the cover flap is held by embossed projections, which project in the openings without applying a clamping force, in such a way that some sort of “play” is provided, allowing thermally induced dimensional changes of the cover flap to be compensated for in such a way that the cover flap can be held without stresses along its entire length. Temperature-induced leakages caused by wave formations in the cover flap, which occur as a result of different thermal expansions of the materials used in the ventilation flap arrangement, are thus avoided effectively.

As the cover flap is exposed to significantly lower stress levels all the while being held securely in the receiving groove, it is possible to use thinner materials for the soft elastic cover flaps while ensuring a constantly good sealing effect, which reduces the noise development occurring when the flap is being closed.

Finally, the more stable attachment of the thinner cover flap to the frame of the ventilation flap arrangement in such a way that it is exposed to lower stress levels results in a quicker response time of the cover flap, with the rear ventilation system opening and closing more rapidly. Furthermore, this again results in a reduced noise development.

In one preferred further development, the openings can be configured as elongate holes or punched slots the longitudinal extension direction of which runs parallel to the adjacent edge of the clover flap. The play provided by the openings is thus greater in the longitudinal direction of the cover flap and, therefore, in the direction of the greater thermal expansion, which facilitates a stress-free mounting of the cover flap.

According to a preferred embodiment, the punched slots are provided with notched relief holes at their ends to prevent the punched slots from tearing, which helps to improve the reliability and service life of the cover flap.

According to a preferred dimensional relationship of the clamped section and the clamping-free mounting of the cover flap, the clamped section of the cover flap, which is acted upon in a clamping manner, has a length of approx. 10% to 15% of the longitudinal dimension of the cover flap, in particular approx. 1.0 cm to 1.5 cm. This is an advantageous compromise between a high retaining force and a clamping-free mounting.

Furthermore, it is possible to provide two to six, preferably four openings for the clamping-free mounting on both sides of the clamped central area of the cover flap to achieve the same goal.

Suitable soft elastic materials for the cover flaps are extruded EPDM, extruded thermoplastic elastomers such as TPS, TPO, TPV, TPC, TPU, TPA or a thermoplastic elastomer processed to form the cover flap by injection molding or compression injection molding. In the case of a compression injection-molded thermoplastic material, the molding tool is continued to be compressed via the tool shearing edge using the compression stroke of the injection molding tool when or just after the molding tool has been filled, allowing the wall thickness of the cover flap to be reduced even more. This in turn results in a less deformed flap, which is therefore less prone to wave formation and, therefore, leakages.

To facilitate an insertion of the cover flaps in the respective receiving grooves, these may be configured such as to taper in the direction of the groove base.

A method according to the invention for the production of a ventilation flap arrangement as set out above comprises, along with the provision of one or of a plurality of flexible cover flaps and of a frame with a receiving groove formed by two side cheeks, the insertion of the cover flap in the receiving groove between the two side cheeks and the non-detachable connection of the cover flap with the receiving groove by embossing. The embossing operation is carried out in such a way that the cover flap is acted upon in a clamping manner only in its longitudinal-edge clamping area, preferably central area, and the at least one side cheek projects, with in each case one embossed projection, in one or a plurality of openings formed close to the longitudinal edge on one side of this clamping area or on both sides of the longitudinal-edge central area of the cover flap in such a way that no clamping force is applied thereto.

Along with the advantages discussed at length above, a method of this type still has few manufacturing steps. Forming the at least one side cheek using an embossing die, preferably using a common embossing tool in one manufactoring step, such that an embossed projection of the at least one side cheek projects in openings formed close to the edge of the cover flap without applying a clamping force, allowing the cover flap to be held in a clamping manner in a clamping area, can be carried out in an automated and economical manner By producing the embossed projections of the side cheeks by an embossing die pair acting thereon on both sides, the maximum forming of the side cheeks is reduced. Exposing the region of the side cheek to be embossed to temperatures in the range between a dimensional stability temperature and a melting temperature of a material to be embossed and/or in particular using ultrasound increases the formability of the material of which the side cheeks are made.

Finally, the invention relates to an embossing die for use in the method according to the invention, said embossing die having an embossing edge with protruding embossing teeth, wherein according to a preferred embodiment, the embossing teeth producing the clamping in the central area of the cover flap may protrude slightly, in particular in the range of a tenth of a millimeter, beyond the remaining embossing teeth. The embossing tool is thus optimally adapted to the various embossing zones in the individual cover flaps.

Further advantageous embodiments of the invention will emerge from the sub-claims the features and details of which will be explained in more detail in the following description, taken in conjunction with the drawing.

### BRIEF DESCRIPTION OF THE DRAWING

FIGS. 1 and 2 show cross-sectional views of a ventilation flap arrangement in various embodiments,

FIGS. 3 to 6 show plan views of cover flaps in various embodiments,

FIG. 7 shows an enlarged detail cross-sectional view of a cover flap during its attachment to a frame in a first intermediate production step,

FIG. 8 shows a cross-sectional view, analogous to FIG. 7, in the region of an edge opening of the cover flap in a subsequent intermediate production step with a one-sided embossing operation,

FIG. 9 shows an even more enlarged cross-sectional view, analogous to FIG. 8, with a formed side cheek of a receiving groove,

FIG. 10 shows a cross-sectional view, which is offset in relation to FIG. 9, of a cover flap in the central area with a formed side cheek, and

FIG. 11 shows a partly cut view of an embossing die.

### DESCRIPTION OF THE PREFERRED EMBODIMENTS

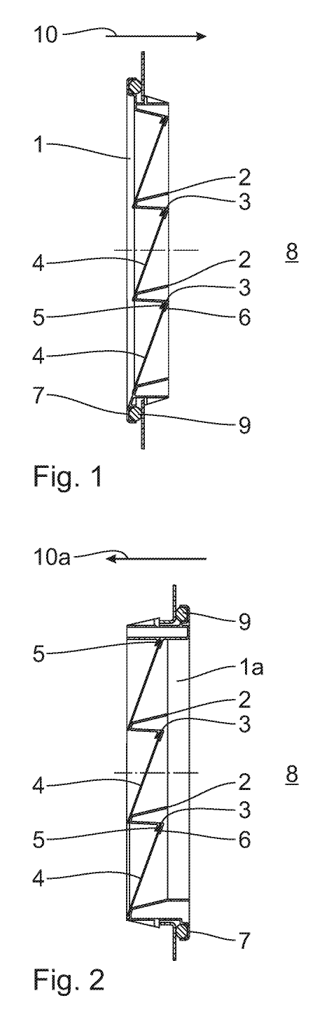

The ventilation flap arrangements shown in FIGS. 1 and 2 have a frame 1, 1a with a plurality of support ribs 2 and a plurality of receiving grooves 3 to hold cover flaps 4, each receiving groove 3 being formed by two side cheeks 5, which are molded in one piece with the frame 1, 1a.

The frame 1, 1a has an assembly shoulder 7 for attaching the ventilation flap arrangement in a venting channel, in particular of a motor vehicle. A seal 9 may be provided in the assembly shoulder 7 for air-tight sealing of a vehicle interior 8 with respect to the venting channel. To attach the ventilation flap arrangement in the venting channel to vent a vehicle interior 8, the ventilation flap arrangement is inserted into the venting channel along an assembly direction 10, 10a. An assembly of the ventilation flap arrangement from an opening of the venting channel opposing the vehicle interior 8 in the direction of the motor vehicle interior 8 takes place in the assembly direction 10 and an assembly of the ventilation flap arrangement from the motor vehicle interior 8 into the venting channel takes place in the assembly direction 10a. The assembly shoulder 7 is used for a defined positioning of the ventilation flap arrangement in the venting channel.

The cover flaps 4 made of flexible, extruded EPDM material having a thickness of 0.5 mm, for example, are each held by a receiving groove 3, which is formed by two side cheeks 5 provided on a support rib 2, the cover flaps 4 in the rest state, i.e. there is no venting, resting in a sealing manner on a support rib 2 adjacent to the support rib 2 being used to hold the cover flap 4. This ensures that the ventilation flap arrangement allows an escape of air from the vehicle interior 8 into the venting channel in the manner of a check valve and simultaneously prevents air flowing from the venting channel into the vehicle interior 8.

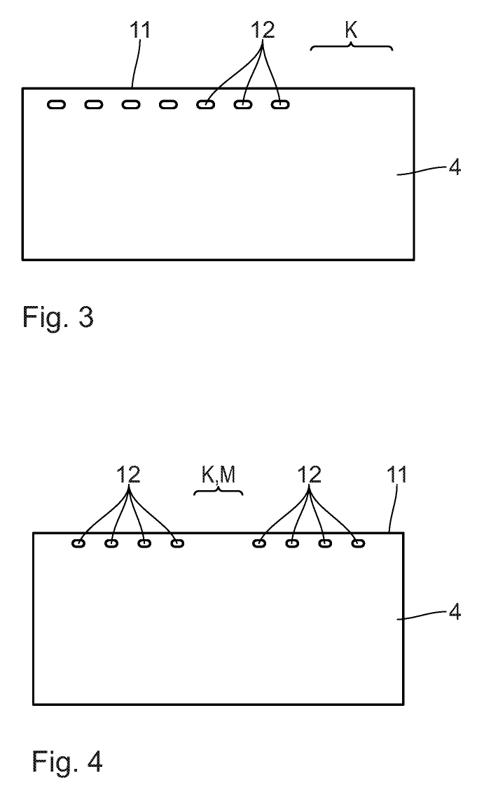

In FIGS. 3 to 6, flexible cover flaps 4 of this type are now shown in various embodiments. Basically all cover flaps 4 shown have a rectangular outline. The embodiment shown in FIG. 3 has a plurality of elongate openings 12 arranged close to one of its longitudinal edges 11, the openings 12 being formed at equal distances in a row from one corner in the direction of the other corner, with a clamping area K being formed in front of that corner where no such openings 12 are provided.

In the embodiments shown in FIG. 4, these openings 12 provided close to the longitudinal edge are in each case arranged in groups of four. The longitudinal extension direction of the openings 12 runs parallel to the longitudinal direction of the cover flap 4. In the central area M of the longitudinal edge 11, which forms the clamping area K in these embodiments, no such openings 12 are provided.

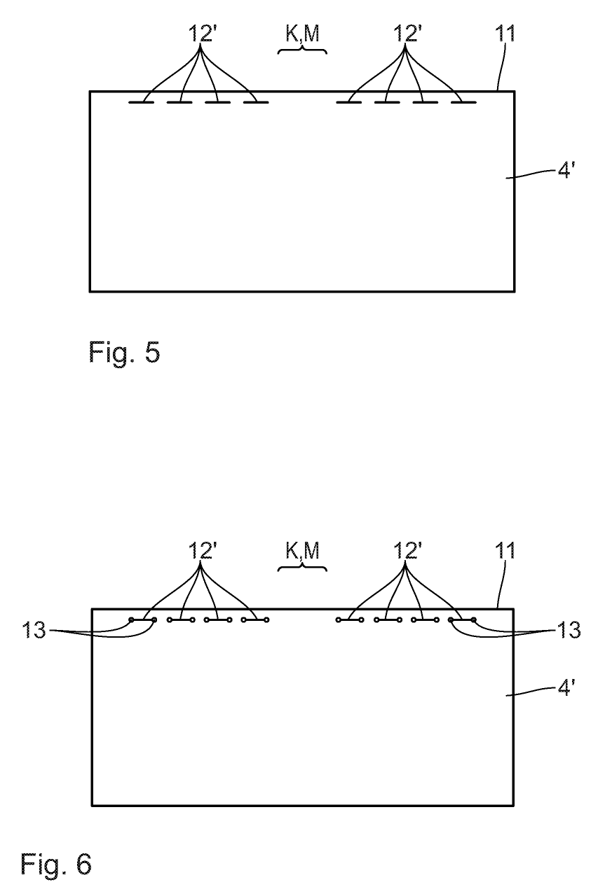

FIG. 5 shows a cover flap 4′, which is similar to the flap shown in FIG. 4, said cover flap 4′ having openings configured as punched slots 12′ with a corresponding orientation formed close to the longitudinal edge, which are again arranged in two groups of four with a central area M where no such openings are provided.

In the embodiment according to FIG. 6, the punched slots 12′ of the cover flap 4′ are additionally provided with notched relief holes 13 at their ends.

The dimensions of the openings 12 or punched slots 12′ are in the singledigit millimeter range. The clamping area K or central area M of the cover flaps 4, 4′ shown has a length of approx. 10% to 15% of the dimension of the cover flaps 4, 4′ in the longitudinal direction. Typical lengths of the central area are thus in the range of 1.0 cm to 1.5 cm.

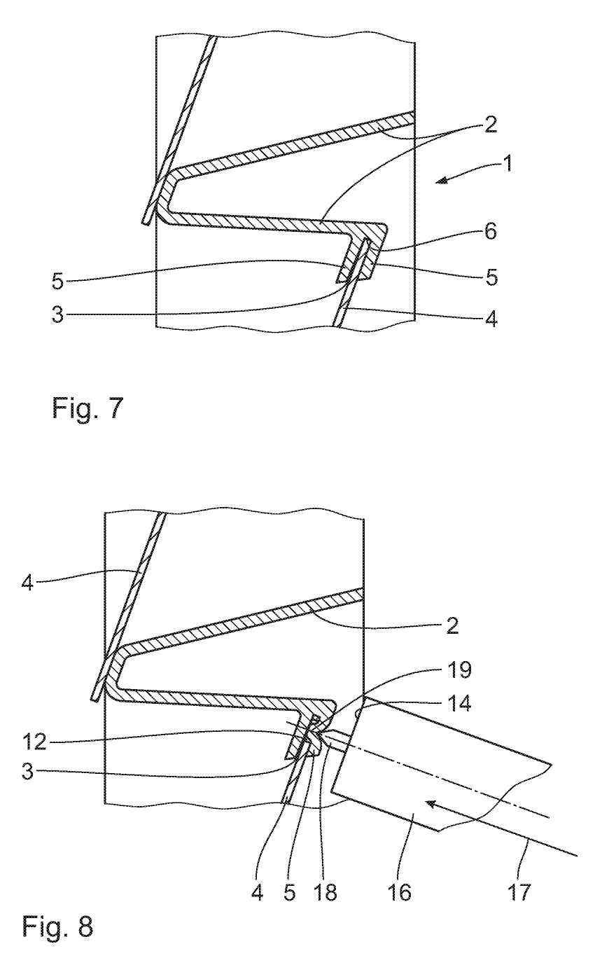

FIG. 7 shows the attachment of a cover flap 4 according to FIG. 4 to a frame 1 in a first production step. For this purpose, the cover flap 4 is inserted in a receiving groove 3, which is formed by two side cheeks 5 and tapers toward a groove base 6 (not shown explicitly), so the insertion of the cover flap 4 into the receiving groove 3 is facilitated additionally.

FIG. 8 then shows a one-sided embossing process for the non-detachable connection of the cover flap 4 with the receiving groove 3 on a support rib 2 by means of an embossing die 16. The geometry of the embossing die 16 is adapted to the respective shape of the support ribs 2, of the frame 1, of the receiving groove 3, and of the cover flap 4 as well as to the material to be embossed. The embossing direction 17 may also be selected in accordance with a desired visibility of an embossing.

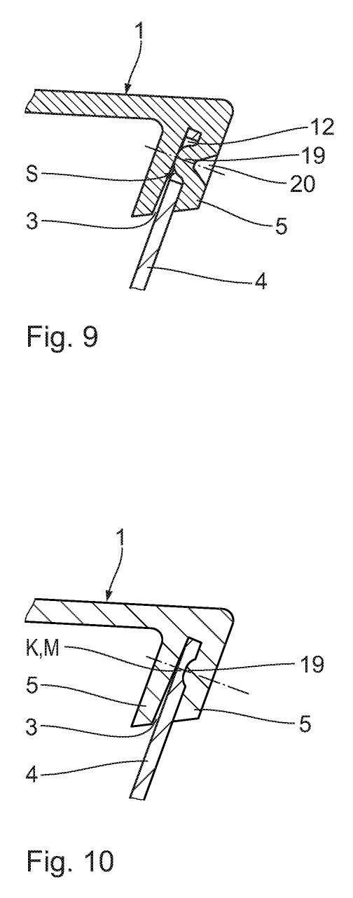

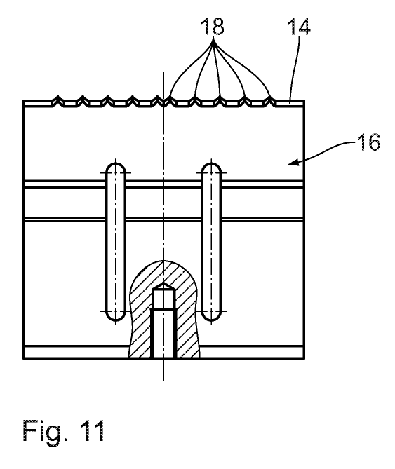

The embossing die 16 as shown in FIG. 11 has embossing teeth 18 along its embossing edge 14, which—in the case of the embossing direction 17 shown in FIG. 8—act on the side cheek 5 from outside. The embossing teeth 18 are arranged such that in each case two groups of four teeth are provided on both sides of the center in such a way that the openings 12 or punched slots 12′ are in line with each other, with the result that embossed projections 19 are formed by the embossing operation, which project into these openings 12 or punched slots 12′. This is shown in FIGS. 8 and 9. The connection between the cover flap 4 and the receiving groove 3 is thus provided with a play S there, so thermal expansions of the cover flap 4 will cause less deformation.

The cross-section of FIG. 9 was performed through the central area M of the cover flap according to FIG. 4 where the central embossing teeth 18 of the embossing die 16 each produce an embossed projection 19, which acts upon the cover flap 4 in a clamping manner there so as to ensure that the cover flap 4 is held securely in the receiving groove 3.

An illustration similar to FIG. 10 is obtained if the cross-section is performed through the clamping area K of a cover flap 4 according to FIG. 3.

In order to obtain a complete description of the embossing die 16 with reference to FIG. 11, it shall be noted that the two central embossing teeth 18 acting upon the respective cover flap 4 in the central area M protrude a few tenths of a millimeter, for example 0.2 mm, beyond the teeth 18 arranged at the sides. Different arrangements of these embossing teeth 18 such as an arrangement without protrusion or even with a recess are conceivable. Moreover, the embossing die 16 is configured as a sonotrode so embossing takes place under the influence of ultrasound.

What is claimed is:

1. A ventilation flap arrangement, comprising
one of the group comprising one and a plurality of flexible cover flaps and
a frame for holding the cover flaps, the frame having a receiving groove for a cover flap, the receiving groove being formed by two side cheeks, and the cover flap being non-detachably connected, at its longitudinal edge, with the receiving groove of the frame by embossing,
wherein this embossed connection
acts upon the cover flap in a clamping manner in a longitudinal-edge clamping area thereof, and
one of the group comprising one and a plurality of openings formed close to the longitudinal edge are in each case provided at least on one side of the longitudinal-edge clamping area of the cover flap, with at least one side cheek projecting therein with in each case one embossed projection without applying a clamping force.

2. The ventilation flap arrangement as claimed in claim 1, wherein it is configured for venting a motor vehicle interior.

3. The ventilation flap arrangement as claimed in claim 1, wherein the cover flap is acted upon in a clamping manner in a longitudinal-edge central area configured as clamping area, and the in each case one of the group comprising at least one and the plurality of openings formed close to the longitudinal edge are provided on both sides thereof to hold the cover flap without applying a clamping force.

4. The ventilation flap arrangement as claimed in claim 1, wherein the openings are each configured as one of the group comprising elongate holes and punched slots the longitudinal extension direction of which runs parallel to the adjacent edge of the cover flap.

5. The ventilation flap arrangement as claimed in claim 4, wherein the punched slots are provided with notched relief holes at their ends.

6. The ventilation flap arrangement as claimed in claim 1, wherein the clamping area of the cover flap, which is acted upon in a clamping manner, has a length of approx. 10% to 15% of the longitudinal dimension of the cover flap.

7. The ventilation flap arrangement as claimed in claim 6, wherein the central area of the cover flap, which is acted upon in a clamping manner, has a length of approx. 10% to 15% of the longitudinal dimension of the cover flap.

8. The ventilation flap arrangement as claimed in claim 6, wherein said length amounts to approx. 1 cm to 1.5 cm.

9. The ventilation flap arrangement as claimed in claim 1, wherein two to six openings provided on both sides of the central area of the cover flap.

10. The ventilation flap arrangement as claimed in claim 9, wherein four openings are provided on both sides of the central area of the cover flap.

11. The ventilation flap arrangement as claimed in claim 1, wherein the cover flaps are made of a soft elastic material, which is selected from one of the group comprising
an extruded EPDM,
an extruded thermoplastic elastomer such as one of the group comprising TPS, TPO, TPV, TPC, TPU and TPA, and
a thermoplastic elastomer processed to form the cover flap by one of the group comprising injection molding and compression injection molding.

12. The ventilation flap arrangement as claimed in claim 1, wherein the receiving grooves are configured such as to taper in the direction of their groove base.

13. A method of producing a ventilation flap arrangement, comprising the following method steps:
providing one of the group comprising one and a plurality of flexible cover flaps,
providing a frame for holding the cover flaps, wherein the frame has a receiving groove for a cover flap, the receiving groove being formed by two side cheeks,
inserting an edge of the cover flap between the two side cheeks of the receiving groove of the frame, and
non-detachably connecting the cover flap with the receiving groove by embossing,
wherein the embossing operation is carried out in such a way that
the cover flap is acted upon in a clamping manner only in its longitudinal-edge clamping area, and
on both sides of the longitudinal-edge clamping area of the cover flap, the at least one side cheek projects, with in each case one embossed projection, in one of the group comprising one and a plurality of openings formed close to the longitudinal edge without applying a clamping force.

14. The method as claimed in claim 13, wherein the embossing operation is carried out in such a way that the cover flap is acted upon in a clamping manner only in its central area.

15. The method as claimed in claim 13, wherein on both sides of the central area of the cover flap, the at least one side cheek projects, with in each case one embossed projection, in one of the group comprising one and a plurality of openings formed close to the longitudinal edge without applying a clamping force.

16. The method as claimed in claim 13, wherein the application of a force on the side cheeks for clamping the clamping area of the cover flap and the formation of the embossed projections is produced by one of the group comprising an embossing die acting thereon on one side and an embossing die pair acting thereon on both sides.

17. The method as claimed in claim 16, wherein the application of a force on the side cheeks for clamping the central area of the cover flap and the formation of the embossed projections is produced by one of the group comprising an embossing die acting thereon on one side and an embossing die pair acting thereon on both sides

18. The method as claimed in claim 16, wherein the clamping of the clamping area of the cover flap and the formation of the embossed projections are carried out at the same time in one manufacturing step by means of one of the group comprising an embossing die and an embossing die pair acting thereon on both sides.

19. The method as claimed in claim 18, wherein the clamping of the central area of the cover flap and the formation of the embossed projections are carried out at the same time in one manufacturing step by means of one of the group comprising an embossing die and an embossing die pair acting thereon on both sides.

20. The method as claimed in claim 13, wherein the area of the at least one side cheek to be embossed is exposed to ultrasound.

21. An embossing die for use in a method as claimed in claim 13 for the production of a ventilation flap arrangement, wherein the embossing die has an embossing edge with protruding embossing teeth.

22. The embossing die as claimed in claim 21, wherein the embossing teeth providing the clamping of one of the group comprising the clamping area and the central area protrude slightly beyond the remaining embossing teeth.

23. The embossing die as claimed in claim 22, wherein the embossing teeth providing the clamping of one of the group comprising the clamping area and the central area protrude beyond the remaining embossing teeth in the range of a tenth of a millimeter.
